(19) United States
(12) Patent Application Publication
(10) Pub. No.: US 2004/0104581 A1
(43) Pub. Date: Jun. 3, 2004

(54) Door lock

(76) Inventors: Manfred Lorek, Siegen (DE); Hans Volkel, Siegen (DE)

Correspondence Address: PEARNE & GORDON LLP, 1801 EAST 9TH STREET, SUITE 1200, CLEVELAND, OH, 44114-3108, US

(21) Appl. No.: 10/473,385

(22) PCT Filed: Dec. 11, 2002
(86) PCT No.: PCT/EP02/14066

(30) Foreign Application Priority Data
Dec. 11, 2001 (DE) 101 60 621.4

(51) Int. Cl. E05C 5/00

(52) U.S. Cl. 292/109

(57) ABSTRACT

The present invention relates to a locking system for two parts movable with respect to one another, of a closure system, door and relating stop in particular, of a refrigerator as well as a refrigerator, for a camping vehicle in particular, in which an engagement member which can be arranged on a first part of said closure system (refrigerator housing) and a receiving member (2) which can be arranged on the second part of said closure system (refrigerator door) are movably arranged with respect to one another so that they come into mutual engagement independently from said closure system (refrigerator housing—refrigerator door) and can be mutually detached again, wherein said receiving member (2) is formed such that it comprises at least to possibilities of reception for said engagement member (1) so that said locking system comprises at least two locking positions, one position in particular in which said refrigerator is closed and one position in which said refrigerator is opened at least partly.

The present invention quite generally pertains to a lock for closing systems, door locks in particular, and here particularly dock locks for refrigerators, wherein preferably refrigerators for leisure vehicles, like e.g. caravans, camping cars etc., are employed.

In a great variety of locking systems it is necessary to provide for a lock avoiding unintentional opening. This also is particularly true for doors in refrigerators used in leisure vehicles, like e.g. caravans, camping cars etc. In those refrigerators due to vibrations during driving unintentional opening of the refrigerator door may occur, which may result in a loss or damage of the articles contained in the refrigerator as well as damage or injury of other objects and/or persons, respectively, which are in front of the refrigerator. To avoid this a door lock has to be provided for which avoids uncontrolled opening of the door.

Door locking systems and/or locking systems in general, for all possible kinds of closures, have been known already. However, closing systems of that kind in most cases comprise only one locking position by which—with respect to the case of refrigerator doors—either the refrigerator doors is kept closed or not. This, however, is not satisfactory for refrigerators, since for refrigerators which are not used for a long period of time it is desirable to keep them open for a small gap for aeration of the inner space in order to avoid creation of mold and smell. Just in refrigerators for caravan vehicles and the like such is desirable because these refrigerators often are not operated for long periods of time. In this case, however, the refrigerator door then has to be kept in an unsecured condition as the locking systems permit locking in case of completely closed door only.

Therefore, it is an object of the present invention to create a locking system in which in a closure system, a door lock for refrigerators in particular, securing of the door in several positions, in at least two positions of the door, is rendered possible. In addition, this locking system is to be of simple construction and easy handling as well as is to require only small space demand.

This object is solved by a locking system under claim 1. Preferred embodiments are subject of the depending claims.

The locking system in accordance with the present invention essentially comprises two elements. Those two elements are fixed to the two elements to be interlocked, of a closure system, e.g. to the door and the relating door stop. While the one element preferably is fixed to the housing of a refrigerator e.g. in farthest rigid manner, the other element preferably is embodied as lifting member and is pivotally arranged on the door e.g. of a refrigerator. A locking hook e.g. in form of a pin which can engage with a locking member of complementary shape on the corresponding counterpart of said locking mechanism, like e.g. a slot-shaped recess, is preferably provided for either on said lifting member or on said rigid element. For permitting several locking positions of the locking mechanism several locking hooks an/or locking members are provided for, which in case of mutual engagement define several locking positions.

Preferably the rigid element and/or the lifting member essentially are embodied as flat metal plates, this resulting in a low structural height.

The locking hooks and elements preferably are embodied as pins and slots realized complimentary thereto so that by a movement of the lifting member the pins engage with the slots and can be released again.

For avoiding an unintentional mutual detaching of the locking hooks and elements corresponding safety means are provided for, like e.g. the arc-shaped embodiment of the slot or the arrangement of heads on the pins.

Further advantages, characteristics and features of the present invention become clear from the following detailed description of an embodiment by means of the attached drawing.

In the drawing

FIG. 1 shows the two essential elements of the door lock in accordance with the present invention;

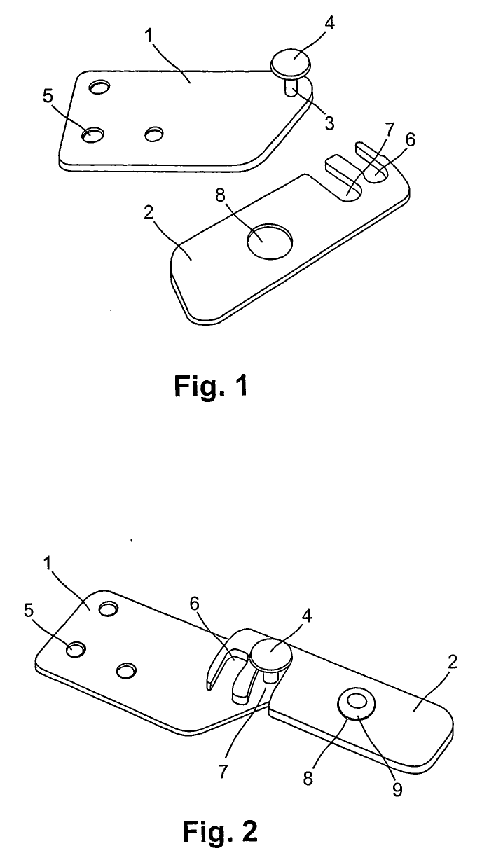

FIG. 2 shows the two parts of FIG. 1 in a locking position;

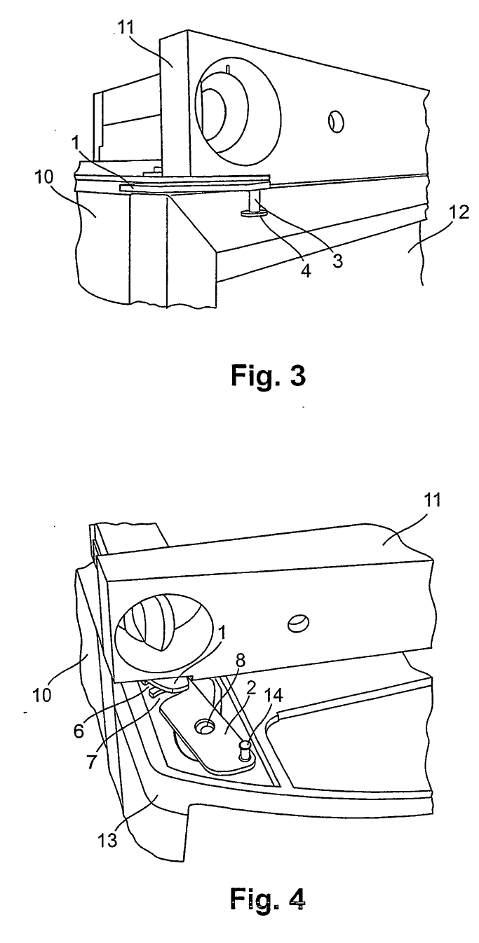

FIG. 3 shows the installation of one of the parts of FIG. 1 in a refrigerator;

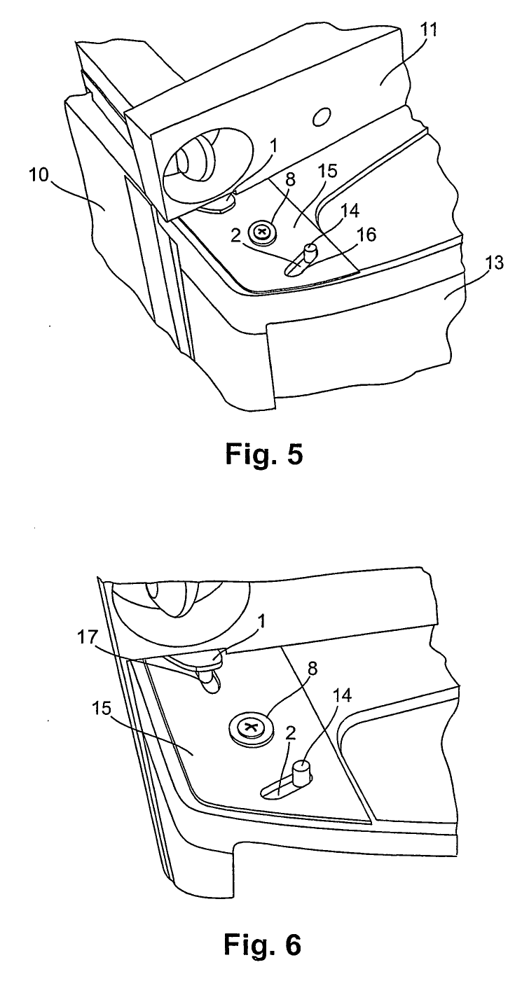

FIG. 4 shows the cooperation of the two parts of FIG. 1 in a door lock at a refrigerator door;

FIG. 5 shows the further installation of the door lock under the preceding figures, in a refrigerator door;

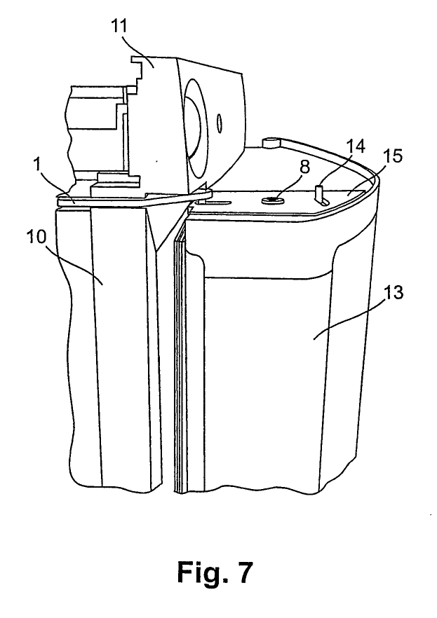

FIG. 6 shows the door lock under FIG. 5 in a further locking position in which the refrigerator door is opened by a gap and

FIG. 7 shows the locking position of FIG. 6 in a side view.

FIG. 1 shows the essential elements of the door lock in accordance with the present invention, namely the metal plate 1 and the lever 2. Said two parts in accordance with the present invention are fixed in correspondingly opposing manner on the partners of a door lock, namely door and stop socket or quite in general on the movable locking member and the relating stop, e.g. window wing and window frame etc. In particular, however, said door lock is intended for refrigerators and here particularly for refrigerators in leisure vehicles like caravans and camping vehicles etc.

For this intended use said metal plate 1, as can be seen from the following figures, preferably is arranged on the housing of the refrigerator, whereas said lever 2 is provided for on the refrigerator door. For its mounting on said housing of a refrigerator said metal plate 2 comprises bores 5, e.g. for passage of screws or the like, wherein in the shown embodiment three bores are provided for which define the corner positions of a triangle. In addition said metal plate 1 comprises a pin 3 comprising a head or rim 4 on its end opposing said metal plate 1. Said pin 3 can be fixed to said metal plate 1 in usual manner, by welding or soldering in particular.

Said lever 2 comprises a swiveling opening 8 by which said level can be pivotally fixed to said door of said refrigerator. On one end of said lever 2 two slots 6 and 7 are provided for whose slot width is harmonized with the diameter of said pin 3. Said slots 6 and 7 are embodied in slight arc shape, wherein the bend of said slots is harmonized to the length of said swiveling opening 8 so that said pin 3 when it is received in the end section of said slots 6 or 7 is held in said slots in case of a tensile load along the longitudinal direction of said lever 2, since said arc-shaped bend of said slots 6 and 7 acts against a movement along said slots 6 or 7. The collar 4 on the end of said pin 3 is built in its diameter such that said pin 3 cannot leave said slots 6 or 7 in longitudinal direction of said pin, i.e. perpendicularly to said lever 2.

FIG. 2 schematically shows the cooperation of said metal plate 1 and said lever 2 in a locking position. In the shown locking position said pin 3 is received in the end section of said slot 7. This represents a locking position of the two alternative locking positions defined by said two slots 6 and 7. To detach said locking position, said lever 2 is pivoted around said swiveling opening 8 so that said pin 3 leaves said slot 7. Thus, said door to which said lever 2 is fixed usually is free with respect to the stop element, e.g. a refrigerator housing on which said metal plate 1 is arranged usually so that said door can be opened. To facilitate rotation of said lever 2 a slide bush 9 or a bearing element is inserted in said swiveling opening preferably.

FIG. 3 shows the arrangement of said metal plate 1 (part 1) on said housing of a refrigerator for a caravan. In the shown embodiment said metal plate 1 is arranged between the switch panel 11 of said housing and the cooling compartment 10 of said housing, said pin 3 with its head or collar 4 protruding downwardly. Reference numeral 12 denominates the opening of said cooling compartment 10 which is closed by the door 13.

FIG. 4 shows the arrangement of said lever 2 (part 2) on said door 13 by which door said opening 12 of said cooling compartment 10 from FIG. 3 can be closed. In lever 2 inserted in FIG. 4 a pin-shaped actuation member 14 with which said lever 2 can be pivoted about said swiveling opening 8 on said refrigerator door 13 is provided for on the upper side of said plate-shaped lever. As can be seen from FIG. 4, said refrigerator door 13 can be locked using said metal plate 1 and said lever 2 with said cooling compartment 10 and said housing, respectively, of said refrigerator, in that said lever 2 with said actuation member 14 is pivoted in such manner that said pin 3 engages with one of said slots 6 or 7. Since said swiveling opening 8 and thus the center of rotation of said lever 2 and said arc-shaped slots 6 and 7 are harmonized with one another in such way that in case of tensile load, i.e. a try to open the door, said pin 3 cannot slide out of said slots 6 and 7, a secure locking position is guaranteed.

For detaching said lock, said lever 2 only has to be pivoted by actuation of said actuation member 14, namely in the shown embodiment to the left side, and said slots 6 and 7 due to the pivot to the right-hand side release said pin 3 and thus give free said door 13.

It FIG. 5 it is shown that said lever 2 can be arranged under a cover 15, said swiveling opening 8 simultaneously serving as place for fixation of said fixation means for said cover 15. In the shown embodiment simply a screw for fixation of said cover is arranged on said door 13 through said swiveling opening 8.

In order to furtheron being able to pivot said lever 2, said cover 15 comprises a recess 16 for said actuation member 15. A corresponding recess 17 is provided also for engagement of said pin 3 (see FIG. 6).

The locking position shown in FIG. 6 is the position in which said door 13 is closed completely, i.e. said pin 3 here engages with said slot 7 of said lever 2. FIGS. 6 and 7 show the locking position in which said refrigerator door 13 is not closed completely, the so-called parking position in which said pin 3 of said metal plate 1 engages with said slot 6 of said lever 2 so that said door 13 is opened for a gap. This is advantageous for refrigerators in particular, which are not operated for a longer period of time, as such is the case in caravan vehicles in particular. The gap-wise opening of said refrigerator namely avoids creation of mold and smell in the appliance and thus serves for increase of utilization quality. Simultaneously, said refrigerator door, however, is held in a defined secured position so that damage and injuries by uncontrolled door movements are avoided. Beside these advantages, the door lock in accordance with the present invention additionally comprises the advantages that it can be installed in a refrigerator in space-saving manner and due to its simple construction does not required excessive expenditure.

In the shown embodiment the locking system in accordance with the present invention is arranged on the stop side of said refrigerator door, i.e. on the side opposite to the side on which said door is pivotally supported with the hinges. Of course, it is self-evident that said locking system can also be arranged in any other suitable place, i.e. on the entire surface of said door in particular, as long as said lock is spaced from said axis of rotation and/or pivot, of said door so that by the lock a rotational or pivotal movement of the door can be prevented.

In a particularly preferred embodiment which is not shown in the drawing said locking arrangement, however, is provided for in central position with respect said door on the upper or bottom side, respectively. This particular place for fixation of said locking system namely has the decisive advantage that said locking system need not be amended when said door stop is to be changed, i.e. e.g. a change has to be taken from a right-hand side stop to a left-hand side stop. In case of a central arrangement on said door said locking system in accordance with the present invention can develop its effect in same manner without any amendment.

What is claimed

1. Locking system for two part movable with respect to one another, of a closure system, a door in particular, and relating stop of a refrigerator, preferably for a camping vehicle, with an engagement member (1) which can be arranged on a first part of said closure system and a receiving member (2) which can be arranged on the second part of said closure system, wherein said engagement and receiving member are movably arranged with respect to one another so that they can be mutually brought into engagement or detached from one another again independently from said closure system,
characterized in that
said receiving member (2) is formed such that it comprises at least two possibilities of reception for said engagement member (1) so that said locking system comprises at least two locking positions.

2. Locking system as defined in claim 1,
characterized in that
said engagement member (1) and said receiving member (2) are formed such that they are self-locking in engagement position in case of actuation of said locking system in particular.

3. Locking system as defined in claim 1 or 2,
characterized in that
said receiving member (2) is embodied as pivotable lever, in the form of a flat plate in particular, with at least two slot-shaped recesses for reception of said engagement member.

4. Locking system as defined in one of the preceding claims,
characterized in that
said engagement member is embodied as rigidly arranged locking hook, in form of a pin in particular, with a head increased with respect to said pin diameter.

5. Locking system as defined in claims 3 and 4,
characterized in that
the diameter of said pin is smaller than the recess width and the diameter of said pin head is larger than said recess width.

6. Locking system as defined in claim 3,
characterized in that
said slot-shaped recesses are made arc-shaped, wherein the shape of said arc and the arrangement of said slot-shaped recess with respect to the axis of pivot of said pivotable lever (2) is chosen such that with actuation of said closure systems in locking position said receiving member (2) and said engagement member are self-locking.

7. Locking system as defined in one of the preceding claims,
characterized in that
said receiving member (2) or/and said engagement member (1) comprise an actuation member (14), in form of grip strip or a slide pin in particular.

8. Locking system as defined in one of the preceding claims,
characterized in that
said receiving member and/or said engagement member are pivotably arranged about a slide bush, wherein fixation on said closure system is effected by said slide bush in particular and a possibly provided sheathing.

9. Refrigerator with a housing and at least one door (13) closing said housing and being pivotably arranged on said housing, as well as at least one locking system (12) as defined in one of the preceding claims.

10. Refrigerator as defined in claim 9,
characterized in that
said engagement member (1) is rigidly arranged on said housing and said receiving member (2) is pivotably arranged on said door (13).

11. Refrigerator as defined in claim 9 or 10,
characterized in that
said locking system is arranged in a plane in parallel to said axis of pivot and centrally with respect to the door width.

12. Refrigerator as defined in one of claims 9 to 11,
characterized in that
said refrigerator door (13) can be locked with respect to the housing by means of said locking system in a closed position and in at least one at least partly opened position.
